(19) United States
(12) Patent Application Publication
(10) Pub. No.: US 2026/0252496 A1
(43) Pub. Date: Aug. 27, 2026

(54) METHOD AND APPARATUS FOR DATA PREFETCH IN A DATA PROCESSING NETWORK

(71) Applicant: Arm Limited, Cambridge (GB)

(72) Inventors: Benjamin Robert Hicks, Newmarket (GB); Jamshed Jalal, Austin, TX (US); Klas Magnus Bruce, Leander, TX (US); Ashok Kumar Tummala, Cedar Park, TX (US); Dimitrios Kaseridis, Austin, TX (US)

(73) Assignee: Arm Limited, Cambridge (GB)

(21) Appl. No.: 19/065,214

(22) Filed: Feb. 27, 2025

(30) Foreign Application Priority Data
Feb. 24, 2025 (EP) 25300006.1

(51) Int. Cl. G06F 12/14

(52) U.S. Cl. CPC G06F 12/14; G06F 2212/602

(57) ABSTRACT

A target network includes a home node, a subordinate node, gateway transmitter and a gateway receiver. The home node is associated with an address in a set of system addresses. The gateway receiver, in response to receiving a read request for data associated with the address from the gateway transmitter of a source network, generates a prefetch message for the address, sends the generated prefetch message to the subordinate node, and forwards the read request to the home node, of the target network. Responsive to receiving the generated prefetch message, the subordinate node retrieves data associated with the address and stores the data in a buffer of the subordinate node. Responsive to receiving a request from the home node, the subordinate node sends the data to the home node. The read request may contain a field indicating that a prefetch message should be generated.

### BACKGROUND

The complexity of data processing networks, such as mesh networks, is increasing in terms of the number of network nodes and the number of networks links. This increase is driven, at least in part, to support large computational and memory requirements. A network may use a system level cache (SLC) to reduce data access latency. In some current systems, the system level cache is distributed across a large set of home nodes in the network to share the cache capacity over all request nodes across multiple chips. The resulting networks, with large mesh dimensions, can exhibit large latencies for the data requests and associated snoop messages.

To reduce memory access latency at a subordinate node of a data processing network, a “prefetch” message may be issued by a request node prior to read request. For example, the data processing network may implement a protocol such as in the Arm® AMBA® 5 CHI specification of Arm Limited. In this specification, the prefetch message is “PrefetchTgt.” The resulting operation does not require a response but can be used by a subordinate node, such as a memory controller, to prefetch the data from memory and store it locally within the subordinate itself. The prefetch message is sent directly from a request node to a subordinate node. This request does not require a response, so it is not tracked as an outstanding request by the request node. In response to the prefetch message, the subordinate node can choose to ignore the request or fetch the data for the specified address. If the subordinate node decides to fetch the data, it buffers it until a normal read request for that address is received. The assumption is that a separate read request will come on the normal path through a coherent home node in the near future. Having the data buffered at the subordinate node reduces the latency of the memory access from a read request and hides any additional latency with local lookups in the home node system cache first.

While this approach reduces latency, it increases network traffic, since two request messages are sent instead of one. This increase in traffic can be detrimental to performance in, for example, applications where the messages pass through a network-to-network link with limited bandwidth.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 is a simplified diagram of a multi-chip data processing network.

FIG. 2 is a block diagram of a chip-to-chip transmitter of a data processing network.

FIG. 3 is a block diagram of a chip-to-chip receiver of a data processing network.

FIG. 4 is a sequence diagram for a read transaction in a data processing network.

FIG. 5 is a sequence diagram illustrating a method for reducing the latency in a read transaction in a data processing network.

FIG. 6 is a sequence diagram illustrating a read transaction with prefetch on a multi-chip data processing network.

FIG. 7 is a sequence diagram illustrating a read transaction on a multi-chip data processing network, in accordance with various representative embodiments.

FIG. 8 is a block diagram of a chip-to-chip transmitter, in accordance with various representative embodiments.

FIG. 9 is a block diagram of a chip-to-chip receiver, in accordance with various representative embodiments.

FIG. 10 is a flow chart of a method of data retrieval in a data processing network, in accordance with various representative embodiments.

FIG. 11 is a diagrammatic representation of a read request with a prefetch hint field, in accordance with various representative embodiments.

FIG. 12 is a sequence diagram illustrating a read transaction in a data processing network, in accordance with various representative embodiments.

### DETAILED DESCRIPTION

The various apparatus and devices described herein provide mechanisms for prefetching data in a data processing network.

Various embodiments of the disclosure relate to efficient communication of a prefetch message across a network-to-network link. The link may couple between networks on the same chip or chiplet or may be a chip-to-chip link in a multi-chip data processing network. Herein, a “chip” is taken to include semi-conductor dies coupled via a printed circuit board (PCB) or semi-conductor dies, sometimes referred to as “chiplets,” packaged in a multi-chip module.

The disclosure is described with reference to a chip-to-chip link between chips (or chiplets) of a multi-chip data processing network. However, it is to be understood that the disclosure may be embodied in other network links. In particular, the link may be between networks on the same chip or between networks on different chips. Thus, the mechanisms used in a chip-to-chip link may be applied in a general network-to-network link. Gateways to the network-to-network link, including gateway transmitters and receivers, are provided in each network.

In one embodiment, a prefetch message is ignored by a gateway transmitter in one network but can be recreated by a gateway receiver of another network, thus enabling latency reduction without negatively impacting bandwidth on a network-to-network link.

An embodiment of the disclosure provides a method for efficient communication of a prefetch message in a data processing network. In accordance with the method, responsive to receiving, from a gateway transmitter of a source network of a data processing network at a gateway receiver of a target network of the data processing network, a read request for data associated with at least a first address of a set of system addresses, the read request is forwarded from the gateway receiver to a home node of the target network. A prefetch message for the address is generated at the gateway receiver and transported from the gateway receiver to a subordinate node of the target network. On receiving the generated prefetch message, the subordinate node retrieves data associated with the first address and stores the data in a buffer of the subordinate node. The subordinate node sends the data associated with the first address responsive to the home node responsive to receiving a request for the data from the home node. When the data associated with the first address is stored at the home node, the data is sent from the home node to a gateway transmitter of the target network. Conversely, when data associated with the first address is not stored at the home node, or any other caching node of the target network, the home node requests the data from the subordinate node. Data received from the subordinate node is sent from the home node to the gateway transmitter of the target network, and the gateway transmitter of the target network sends the data to a gateway receiver of the source network.

In one embodiment, the home node of the target network is identified based on the read request or the first address. Similarly, the subordinate node of the target network may be identified based on the read request or based on the first address.

In one embodiment, responsive to the home node requesting data associated with the first address from the subordinate node of the target network, the subordinate node generates a message including an indication of whether or not the data associated with the first address was stored in the buffer of the subordinate node. The message is transported to the gateway receiver of the target network via the home node. The gateway receiver determines whether a future prefetch message should be generated, or not, based on the indication in the message.

In one embodiment, when data associated with the first address is stored at the home node of the target network, the home node generates a message including an indication that the data associated with the first address was stored at the home node. The message is transported to the gateway receiver of the target network. The gateway receiver determines whether a future prefetch message should be generated, or not based, on the indication in the message.

In a further embodiment of the disclosure, a gateway receiver of a target network of a data processing network receives, from a gateway transmitter of a source network, a read request for data associated with a first address. The read request is sent from the gateway receiver to a home node of the target network. When a value of a designated field of the read request is asserted, a prefetch message is generated at the gateway receiver of the target network and transported from the gateway receiver to a subordinate node of the target network. The designated field may a single bit or multiple bits and will be referred to a “prefetch hint.”

In one embodiment, a request node of the source network generates the read request and sets the value of the designated field in the read request. The read request is then transported to the network-network transmitter of the source network. The read request may be transported via a local caching node of the source network.

In one embodiment, the request node of the source network sends a prefetch message for data associated with the first address prior to generating the read request for data associated with the first address. In this case, setting the value of the designated field in the read request includes asserting the value of the designated field in the read request.

In one embodiment, the prefetch message generated by the request node of the source network is transported to the gateway transmitter of the source network. When a traffic level of a network-to-network link between the source and target network is below a designated threshold, the prefetch message is transmitted over the network-to-network link to the gateway receiver of the target network. When the traffic level of the network-to-network link between the source and target network is not below a designated threshold, the prefetch message generated by the request node of the source network is dropped.

A further embodiment of the disclosure provides an apparatus that includes a target network. The target network includes a home node of a data processing network, a subordinate node of the data processing network, a gateway transmitter and a gateway receiver. The home node and the subordinate are associated with at least a first address in a set of system addresses. The gateway receiver of the target network is configured to respond to receiving a read request for data associated with the first address, from the gateway transmitter of a source network, by forwarding the read request from the gateway receiver to the home node of the target network, generating a prefetch message for the address, and sending the generated prefetch message from the gateway receiver to the subordinate node of the target network. The subordinate node is configured to retrieve data associated with the first address responsive to receiving the generated prefetch message and store the data in a buffer of the subordinate node. The subordinate node is further configured to send data associated with the first address to the home node responsive to receiving a request from the home node.

The home node is configured to send the data associated with the first address from the home node to a gateway transmitter of the target network when data associated with the first address is stored at the home node. When data associated with the first address is not stored at the home node, or any other caching node of the target network, the home node requests data associated with the first address from the subordinate node and sends the data to the gateway transmitter of the target network. The gateway transmitter of the target network is configured to send the data to the gateway receiver of the source network.

In one embodiment, the apparatus also includes the source network and a network-to-network link. The source network, in turn, includes a request node, a gateway transmitter and a gateway receiver. The network-to-network link operatively couples the gateway transmitter of the source network to the gateway receiver of the target network, and couples the gateway transmitter of the target network to the gateway receiver of the source network. The request node is operable to generate a read request for data associated with the first address, and the gateway transmitter of the source network is configured to send the read request to the receiver of the target network via the network-to-network link.

In one embodiment, the gateway receiver of the target network is configured to generate the prefetch message when a designated field in the read request has a first value and to refrain from generating the prefetch message when the designated field in the read request has a value other than the first value. The request node of the source network is operable to send a prefetch message, for data associated with the first address, to the gateway transmitter of the source network, set the designated field of the read request to the first value, and also send a read request for data associated with the first address to the gateway transmitter of the source network, or to a local caching node of the source network.

In one embodiment, the request node includes prediction circuitry configured to determine when to send a prefetch message and set the designated field of the read request to the first value. The determination may be made in response to indications from the home node and/or subordinate node indicating whether the subordinate node fulfilled a prior read request for the first address. The use of prediction circuitry is disclosed in U.S. Pat. No. 10,402,349 to Fillipo et al., for example, the subject matter of which is incorporated herein in its entirety.

In one embodiment, prediction circuitry is located in the gateway transmitter of the source network or the gateway receiver of the target network. The prediction circuitry is configured to determine, based on whether data associated with one or more previous read requests have been sourced from the subordinate node or a cache of the home node, when to send a prefetch message.

In one embodiment. the gateway transmitter of the source network is configured to transmit the prefetch message, generated by the request node of the source network, over the network-to-network link to the gateway receiver of the target network when a traffic level of the network-to-network link is below a designated threshold. The gateway transmitter is further configured to drop the prefetch message when the traffic level of the network-to-network link is not below the designated threshold.

In one embodiment, the gateway receiver of the target network is configured to select between generating and not generating the prefetch message based on whether data associated with one or more previous read requests has been sourced from the buffer of the subordinate node or a cache of the home node.

In one embodiment, the gateway receiver of the target network is configured to select between generating and not generating the prefetch message based on a value of a configuration register.

The data processing network may implement a protocol such as in the Arm® AMBA® 5 CHI specification of Arm Limited. In this specification, the prefetch message is “PrefetchTgt.” The resulting operation does not require a response and can be used by a subordinate node, such as a memory controller, to prefetch the data from memory and store it locally within the subordinate itself.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements. In particular, the disclosure describes embodiments in a chip-to-chip link. More generally, the disclosure may be embodied in any network-to-network link, whether the link is between networks on different chips or between networks on the same chip.

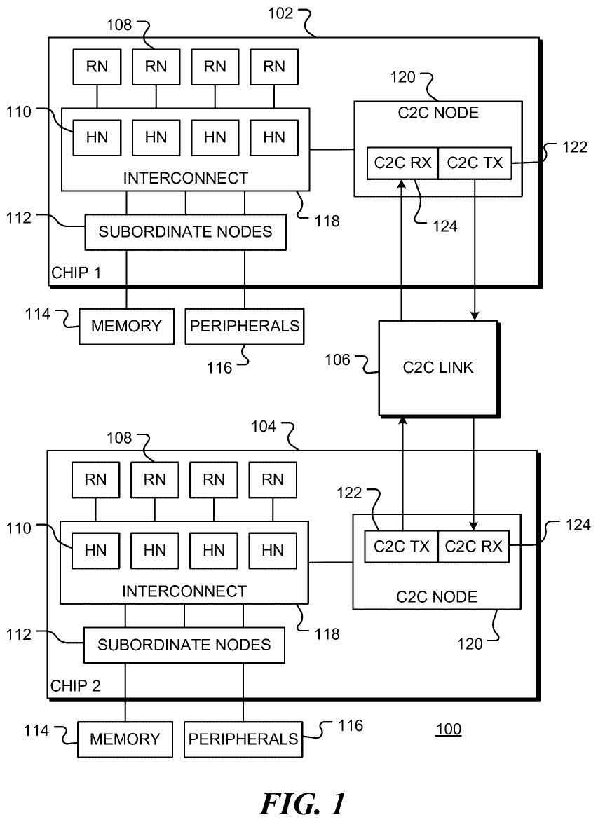

FIG. 1 is a simplified diagram of a multi-chip data processing network 100. The network includes a first integrated circuit chip 102 (“CHIP 1”) and second integrated circuit chip 104 (“CHIP 2”), coupled by chip-to-chip (C2C) link 106 that enables communication of information between the two chips. Each chip includes request nodes (RNs), e.g., 108, home nodes (HNs), e.g., 110, and subordinate nodes 112 (SNs). While a small number of nodes is shown in FIG. 1, a network may contain any number of nodes.

The request nodes (RNs) access and process data. A request node (RN) can be Fully Coherent, input/output (I/O) Coherent, or I/O Coherent with Distributed Virtual Memory (DVM) support. A Fully Coherent Request Node (RN-F) contains coherent caches and will accept and respond to snoop messages for accessing or changing the coherency state of cached data. An I/O-Coherent Request Node (RN-I) does not have a coherent cache, and cannot accept snoop messages. An I/O-Coherent Request Node with DVM support (RN-I/D) has the same functionality as an RNI and can also accept DVM messages. A request node may be, for example, a central processing unit (CPU) core, a neural engine or other accelerator, or a Component Aggregation Layer that houses two or more CPU cores to be connected to one network port.

A network may include a system level cache (SLC) to reduce the number of accesses to memory and reduce the latency of data accesses. The system level cache may be distributed across a large set of home nodes in a network to share the cache capacity over all network nodes across multiple chips. A home node (HN) provides a point of coherency for a subset of system address and provides a cache for storing data associated with the addresses. Coherency may be provided by a snoop filter (SF) that tracks data copied to caches in the network caches.

Subordinate nodes 112 provide access to data sources and sinks, such as memory 114 and peripheral devices 116. A memory or peripheral device may be located off-chip, as shown, or on-chip.

Interconnect 118 provides signal connections between the nodes and may have various topologies. For example, interconnect 118 may be configured to form a mesh network, a ring network, a cross-bar network, or other network. The interconnect may provide a number of cross-points (XPs). Each cross-point provides one more ports for coupling to request nodes and home nodes.

Chip-to-chip nodes (C2C nodes or CCNs) 120 are gateways that couple between the network on one chip and a network on another chip. This enables formation of a network spanning multiple chips.

C2C node 120 includes a transmitter 122 and a receiver 124 that interface to C2C link 106. C2C link 106 is responsible for handling message transport at a FLow control unIT (Flit) granularity. C2C link 106 may also be responsible for data integrity and transport error detection and recovery. This may be done, for example, by adding a generated Cyclic Redundancy Check (CRC) checksum to a flit being transmitted and checking the CRC checksum on the received flit. When an error occurs, the C2C link can use a flit retry mechanism to recover from the error. The C2C link includes a physical layer that is responsible for providing reliable electrical connectivity between the two chips. The physical layer may also include logic to overcome latency skew among different signals, together with link retraining logic to maintain signal integrity. In one embodiment, the container size is 256 bytes and is split into twelve granules or slots of 20 bytes each for messages and 16 bytes for other information. Other sizes and configurations of the container may be used without departing from the present disclosure.

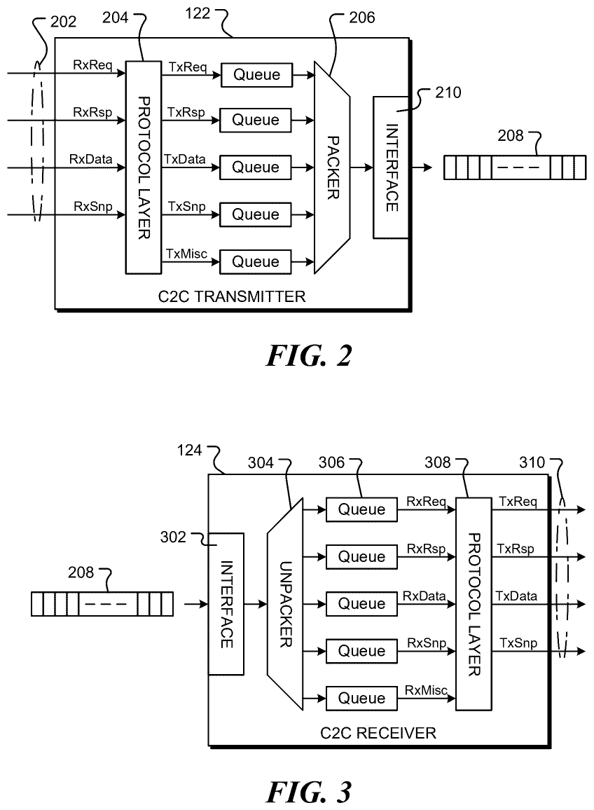

FIG. 2 is a block diagram of a C2C transmitter 122 of a C2C node. Transmitter 122 is an interface component that receives messages from an on-chip interconnect and forwards them to chip pins for coupling to a C2C Link. In the example shown in FIG. 2, the messages are received on four separate channels 202 and include request messages on channel “RxReq,” response messages on channel “RxRsp,” data messages on channel “RxData,” and snoop messages on channel “RxSnp.” The received messages are reformatted for transmission on the C2C link in protocol layer circuit 204. For example, protocol layer circuit 204 may handle protocol conversion between on-chip message format (such as Arm® AMBA® 5 CHI specification of Arm Limited) and a C2C link format (such as Arm® AMBA® CHI C2C of Arm Limited). The reformatted messages are passed on channels “TxReq,” “TxRsp,” “TxData” and “TxSnp,” respectively, together with additional information on channel “TxMisc,” to message queues or buffers and then passed to packer circuit 206, where they are packed into fixed-sized containers, such as container 208, for transmission on the C2C link via interface 210.

A container is the smallest fixed size data structure or unit in which messages are transferred across an interface. In addition to space for messages, a container includes space for C2C link transport information such as a flit header and link reliability information.

Since messages from all of the on-chip channels are packed into the same container, the bandwidth of the C2C link may constrain performance of the data processing network. Embodiments of the present disclosure provide mechanisms for improving the efficiency of a C2C link.

FIG. 3 is a block diagram of a C2C receiver 124. C2C receiver 124 is an interface component that receives message containers 208 from a C2C link at interface 302. The containers are unpacked by unpacker circuit 304 to recover received messages on channels “RxReq,” “RxRsp,” “RxData” and “RxSnp”, respectively, together with additional information on channel “RxMisc”. The messages may be queued in queue buffers 306 before being reformatted in protocol layer circuit 308 from the C2C link protocol to the on-chip message protocol. The reformatted messages are then transmitted to the on-chip interconnect of the chip on channels “TxReq,” “TxRsp,” “TxData” and “TxSnp” (310).

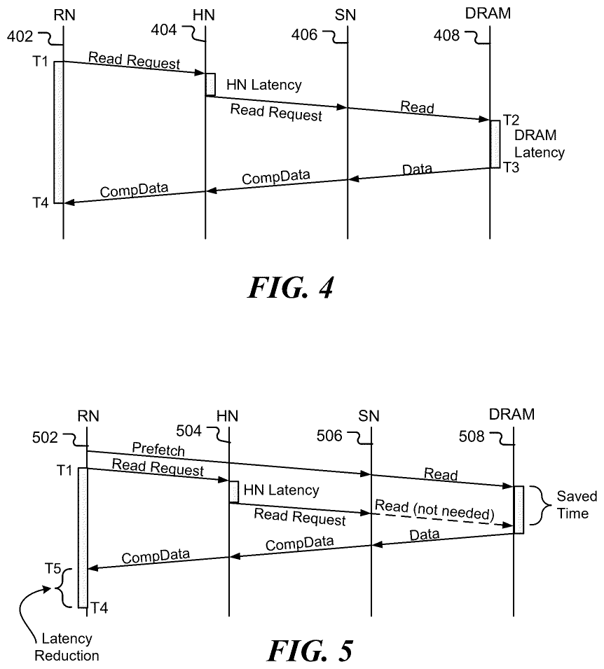

FIG. 4 is a sequence diagram for a read transaction in a data processing network. The diagram shows timeline 402 for a request node (RN), timeline 404 for a home node (HN), timeline 406 for a subordinate node (SN) and timeline 408 for a memory device, such as a dynamic random-access memory (DRAM). Time flows in a downward vertical direction. At time T1, the RN issues a read request for a first data address. The read request is routed to an associated HN for the first data address. The HN checks if the data associated with the first data address is present at the HN. The HN may also send snoop messages to the other RNs and perform any required coherency action. If the data is not present at the HN (or in the cache of any other RN), a read request is sent from the HN to the subordinate node associated with the first data address. The actions by the HN introduce a latency or delay between when the read request was received at the HN and when the subsequent read request is sent to the SN. A further latency, or delay, is introduced as the SN reads the requested data from the DRAM or other source. The request from the SN is received at time T2 and the data is returned to the SN at time T3. The data is then forwarded from the SN to the HN in a “CompData” message that includes an indication that the SN has completed its action. The returned data may or may not be stored in a cache at the HN. Finally, the data is sent from the HN to the requesting RN in another “CompData” message that indicates that the HN has completed actions (including any coherency actions) with respect to the data. The data arrives at the RN at time T4. Thus, the read transaction has a latency of duration T4-T1.

FIG. 5 is a sequence diagram illustrating a method for reducing the latency in a read request in a data processing network. The diagram shows timeline 502 for a request node (RN), timeline 504 for a home node (HN), timeline 506 for a subordinate node (SN) and timeline 508 for a memory device such as a dynamic random-access memory (DRAM). Again, time flows in a downward vertical direction. Referring to FIG. 5, at time T1, the RN issues a read request for a first data address. As in FIG. 4, the read request is routed to an associated HN for data associated with at least a first address. However, a prefetch message is sent at time T0, prior to time T1. The prefetch message is also associated with the address, but is sent to the SN associated with the first address rather than to the HN associated with the first address. The prefetch message indicates to the SN that data associated with the first data address may be requested at a future time. On receipt of the prefetch message, the SN may initiate reading data from the DRAM. Once read, the data may be stored in a buffer at the SN. As in FIG. 4, the HN receives the read request from the RN and, after some latency, sends a read request to the SN. The SN receives the read request from the HN, but does not need to request the data form the DRAM since it has already done so in response to prefetch message. Thus, by use of the prefetch instruction, the process of reading the data from the DRAM starts sooner. Consequently, the data arrives at the RN at time T5, prior to time T4 and latency is reduced by an amount T4-T5. When the requested data is already present at the home node (or in a cache of another RN), the prefetch may provide no improvement.

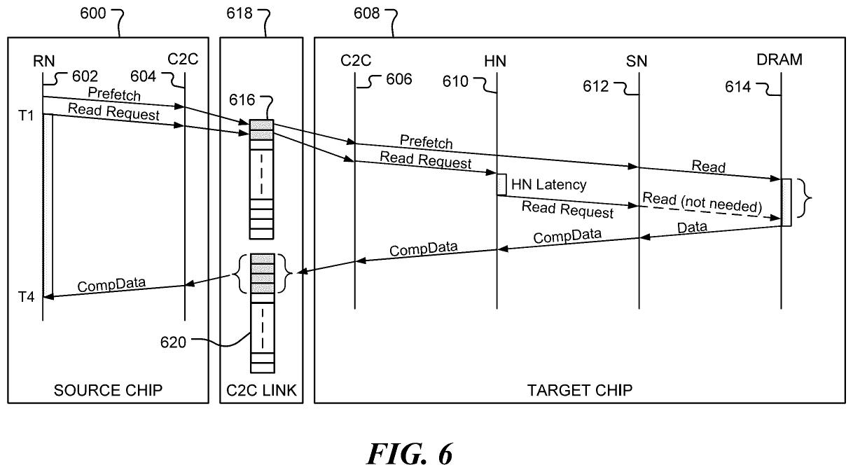

FIG. 5 illustrates the use of a prefetch message when the HN and SN are on the same chip as the requesting RN. When the RN is on a first chip, referred to as the source chip for the read transaction, and the HN and SN are on a second chip, referred to as the target chip for the transaction, the read request is routed from the RN to a C2C node of the source chip as shown in FIG. 6.

FIG. 6 is a sequence diagram illustrating a read transaction with prefetch when the requesting node (RN) is on one chip of a data processing network and the home node and subordinate node are on a different chip of the network. The sequence diagram shows timeline 602 for a request node (RN) of a source chip 600, timeline 604 for a C2C node of the source chip, timeline 606 for a C2C node of target chip 608, timeline 610 for a home node (HN) of the target chip, timeline 612 for a subordinate node (SN) of the target chip and timeline 614 for a memory device such as a dynamic random-access memory (DRAM) accessed via the SN. Again, time flows in a downward vertical direction. Referring to FIG. 6, a prefetch message and a subsequent read request are sent from the RN to the C2C node of the source chip. The C2C node packs the prefetch message into one granule of container 616 for transport in C2C link 618 and packs the read request into another granule of the container (or a subsequent container). The prefetch message and read request are transported via the C2C link to the C2C node of the target chip, where they are unpacked. The prefetch request is sent directly to the subordinate node (SN) of the target chip and the read request is sent to home node (HN). Operation continues, as described above with reference to FIG. 6, except that the data is returned via the C2C nodes and container 620 in C2C link 618. While this approach reduces latency in read requests that must access the DRAM, two granules of C2C link container 616 are utilized. This reduces the number of granules available for other messages. Since the C2C link is a limited resource, the use of the link to transmit an explicit prefetch message may have a negative impact of performance of the data processing network.

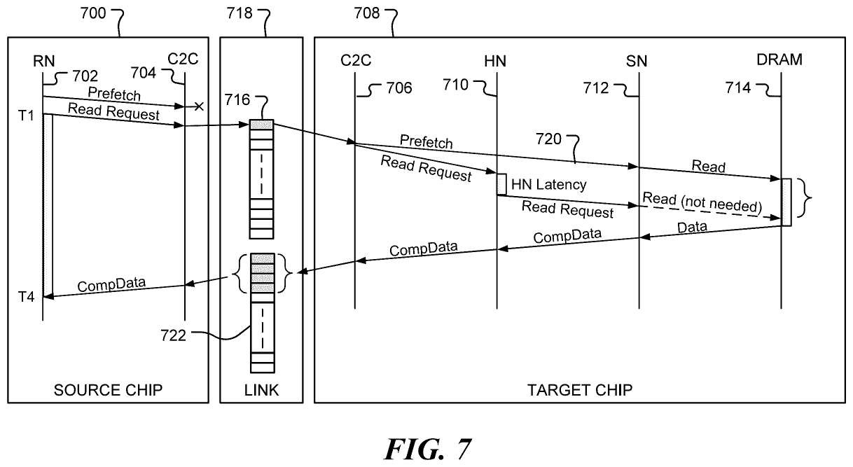

FIG. 7 is a sequence diagram illustrating a read transaction when a requesting node is on one chip of a data processing network and the HN and SN are on a different chip of the network, in accordance with various embodiments of the disclosure. The diagram shows timeline 702 for a request node (RN) of source chip 700, timeline 704 for a C2C node of the source chip, timeline 706 for a C2C node of target chip 708, timeline 710 for a home node (HN) of the target chip, timeline 712 for a subordinate node (SN) of the target chip and timeline 714 for a memory device, such as a dynamic random-access memory (DRAM). Again, time flows in a downward vertical direction. Referring to FIG. 7, the RN of the source chip again sends a prefetch message followed by a read request to the C2C node of the source chip. However, the prefetch message is dropped by the C2C transmitter of the C2C node. The read request is transmitted in container 716 across C2C link 718 to the C2C node of the target chip. On receiving the read request, the C2C receiver of the C2C node of the target chip generates a prefetch message, 720, and sends the generated prefetch message 720 to the SN of the target chip. The read request is sent to the HN of the target chip, as before. In this manner, the latency reduction obtained by use of a prefetch message is maintained, but no container granule is used for a prefetch message. Consequently, the performance reduction of the approach shown in FIG. 6 is avoided. For example, in the case where a sequence of prefetch messages, with corresponding read requests, are issued by the RN, the link capacity is doubled compared to the approach shown in FIG. 6. For example, a 256-byte container with twelve 20-byte granules can transport twelve read requests as compared to six read requests and six prefetch messages when explicit prefetch messages are sent via the C2C link as shown in FIG. 6. When the SN receives the read request from the HN, the request does not result is a read to the memory (as indicated by the dashed arrow from the SN timeline 712 to the DRAM timeline 714), since the data has already been requested from the DRAM in response to the prefetch message. The SN may still track the read and provide a “CompData” completion response to the incoming request. As before, the request data is returned to the RN of the source chip in container 722 in C2C link 718.

In one embodiment, the prefetch message from the RN is always dropped at the C2C transmitter.

In one embodiment, the prefetch message from the RN is dropped at the C2C transmitter when the link traffic level is high, but transmitted when the link traffic level is low.

In one embodiment, the prefetch message from the RN is dropped at the C2C transmitter, or sent via the C2C link, based on the value of a configuration register.

In one embodiment, a prefetch message is generated, or not, by the C2C receiver based on the value of a configuration register.

In one embodiment, a prefetch message is generated, or not, by the C2C receiver based on the value of a designated field of a read request. The designated field may be a single bit or multiple bits.

In one embodiment, a prefetch message is generated, or not, by the C2C receiver based on a predicted benefit of the prefetch message. The predicted benefit may be based, at least in part, on feedback information indicating the source of data in prior read request.

Predictor circuitry may be used to store prediction data indicating whether recent data access requests were fulfilled by a first data source or a second data source and to predict, from the prediction data, whether a next data access request will be fulfilled by the first data source or the second data source, the first and second data sources being arranged so that if a data access request is not fulfilled by the first data source, it is fulfilled by the second data source. The prediction data may include a count value, the predictor circuitry being configured to change the count value in dependence upon whether a recent data access request was fulfilled by the first or the second data source. In another embodiment, the prediction circuitry includes a branch predictor.

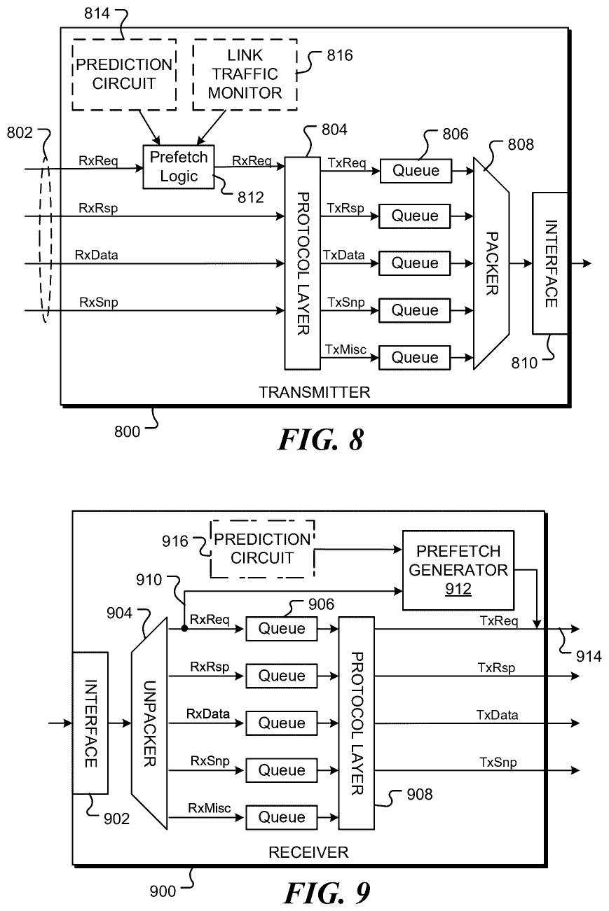

FIG. 8 is a block diagram of a C2C transmitter 800 of a C2C node, in accordance with various embodiments of the disclosure. C2C transmitter 800 is an interface component that receives messages from an on-chip interconnect and forwards them to chip pins for coupling to a C2C Link. In the example shown in FIG. 8, the messages are received on four separate channels 802 and include request messages on channel “RxReq,” response messages on channel “RxRsp,” data messages on channel “RxData,” and snoop messages on channel “RxSnp.” The received messages are reformatted for transmission on the C2C link in protocol layer circuit 804. For example, protocol layer circuit 804 may handle protocol conversion between on-chip message format (such as Arm® AMBA® 5 CHI specification of Arm Limited) and a C2C link format (such as Arm® AMBA® CHI C2C of Arm Limited or a Cache Coherent Interconnect for Accelerators (CCIX®) of CCIX® Consortium, Inc.). The reformatted messages are passed on channels “TxReq,” “TxRsp,” “TxData” and “TxSnp,” respectively, together with additional information on channel “TxMisc,” to message queues or buffers 806 and then passed to packer circuit 808, where they are packed into a container for transmission on a C2C link via interface 810. Incoming requests, such as requests on request channel “RxReq,” are processed in prefetch logic circuit 812. Prefetch logic circuit 812 is configured to drop or pass prefetch messages. In one embodiment, prefetch logic circuit 812 may be controlled by prediction circuitry 814 or configured using configuration registers. Prediction circuitry 814 may be configured to determine, based on whether data associated with one or more previous read requests have been sourced from the buffer of the subordinate node or a cache of the home node, when a prefetch message will be beneficial. The configuration registers may be programmable at boot time or via software, for example. Configuration registers may be set to drop prefetch messages or to pass prefetch messages, for example. In a further embodiment, prefetch logic circuit 812 is configured dynamically based on C2C link traffic monitor 816. When a traffic level of the chip-to-chip link between the source chip and the target chip is below a designated threshold, the prefetch logic is configured to pass the prefetch message for transmission over the chip-to-chip link to the chip-to-chip receiver of the target chip. When the traffic level of the chip-to-chip link between the source chip and the target chip is not below a designated threshold, the prefetch logic is configured to drop the prefetch message and prevent transmission over the C2C link. The designated threshold may be set based on the configuration registers. Thus, when the traffic level is below the threshold, prefetch message are sent over the link. This may be advantageous when a prefetch message is received in advance of an associated read request giving more advanced warning of the read request. When the traffic level is below the threshold, the C2C link has sufficient capacity and does not constrain performance of the data processing network.

When the traffic level is above the threshold, prefetch messages are dropped. An indicator in the associated read request may be asserted to indicate that a prefetch message should be regenerated at the target chip. The indicator may be, for example, a single bit field that is set to the value one to indicate a “hint” to generate a prefetch message and is set to zero to indicate that a prefetch message is unlikely to be beneficial.

When the traffic level is below the threshold, prefetch messages are passed to the C2C link. In this case, the indicator is set to zero to avoid the target chip generating an additional prefetch message.

FIG. 9 is a block diagram of a C2C receiver 900, in accordance with various representative embodiments. C2C receiver 900 is an interface component that receives message containers from a C2C link at interface 902. The containers are unpacked by unpacker circuit 904 to recover received messages on channels “RxReq,” “RxRsp,” “RxData” and “RxSnp”, respectively, together with additional information on channel “RxMisc”. The messages may be queued in queue buffers 906 before being reformatted in protocol layer circuit 908 from the C2C link protocol to the on-chip message protocol. The reformatted messages are then transmitted to the on-chip interconnect of the chip on channels “TxReq,” “TxRsp,” “TxData” and “TxSnp.” Request message on channel “RxReq” are supplied on signal path 910 to prefetch generator 912. Optionally, only read request are passed to prefetch generator 912. Prefetch generator 912 is operable to generate a prefetch message that is transported on request channel 914 (TxReq) to the subordinate node associated with the address in the read request. The prefetch message may be generated based on the value in a designated field of the read request, referred to as a “hint.” The prefetch generator may opt to ignore the hint, based on values in one more configuration registers or on the output of optional prediction circuitry 916. Prediction circuitry 916 may be configured to determine, based on whether data associated with one or more previous read requests have been sourced from the buffer of the subordinate node or a cache of the home node, when a generation of a prefetch message would be beneficial.

In FIG. 9, requests are monitored before entering queue 906. In a further embodiment, requests are monitored as they exit the queue. In a still further embodiment, requests are monitored after protocol conversion in protocol layer 908.

While embodiments using C2C nodes and a C2C link are described above, the disclosed mechanisms have application to gateway nodes or blocks that provide interfaces to a network-to-network link. The network-to-network link may couple between networks on the same chip or on different chips.

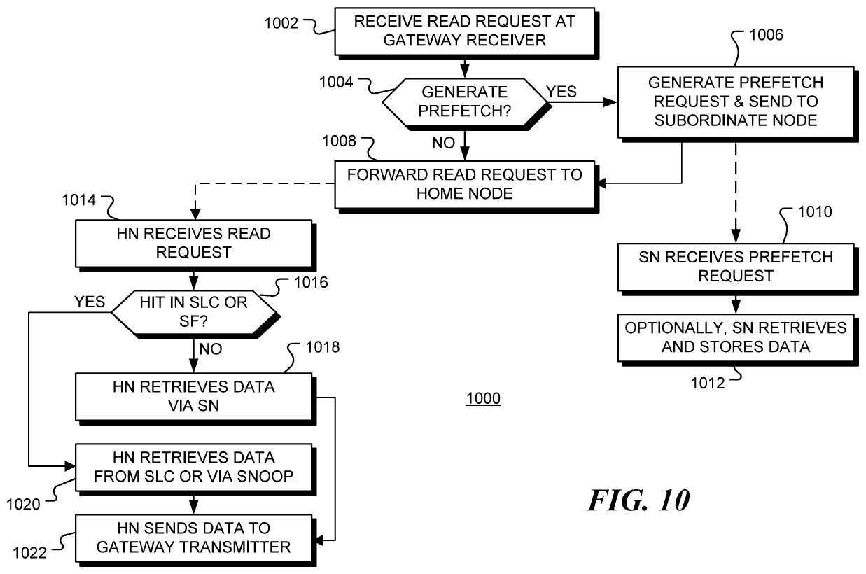

FIG. 10 is a flow chart of a method 1000 of data retrieval in a data processing network, in accordance with various representative embodiments. Referring to FIG. 10, at block 1002 a read request for data associated with at least a first address is received at a gateway receiver of a target network. The read request is received over a network-to-network link from a gateway transmitter of a source network. Responsive to receiving the read request, the gateway receiver determines if a prefetch message for the first data address should be generated at decision block 1004. If so determined, as depicted by the positive branch from decision block 1004, a prefetch message for the data address is generated by the gateway receiver at block 1006 and transported to the subordinate node (SN) of the target network. At block 1008, the read request is forwarded to the HN. Responsive to receiving the generated prefetch message at block 1010, the SN retrieves data associated with the first address at block 1012 and, optionally, stores the data in a buffer of the subordinate node. The data may be retrieved from a memory or peripheral device, for example. The HN receives the read request at block 1014. When the first address misses in the SLC at the HN and in the snoop filter of the HN, as depicted by the negative branch from decision block 1016, the home node retrieves the data associated with the first address via the SN at block 1018. When the data is buffered at the SN, the SN sends the buffered data to the HN, otherwise the SN retrieves the data from a memory or peripheral device and sends it to the HN. When the address hits in the SLC or snoop filter of the home node, as depicted by the positive branch from decision block 1016, the data is retrieved from the SLC or via a snoop operation at block 1020. At block 1022, the data associated with the first address is sent from the home node to the gateway transmitter of the target network to be sent to a gateway receiver of the source network via the network-to-network link.

The home node of the target network may be identified based on the read request. For example, a system address map may be used to map the first address to an identifier of a home node.

The subordinate node of the target network may also be identified based on the read request. For example, a system address map may be used to map the first address to an identifier of a subordinate node.

The read request may be routed to the gateway transmitter of the target network based on the first address. Optionally, the read request may be routed via a local coherency cache of the source network that stores copies of data sourced from the target network.

When the requested data associated with first address is sourced from the buffer of the SN, it is an indication that the prefetch operation has been beneficial. When the requested data associated with first address is sourced from the cache of the HN, it is an indication that the prefetch operation has not been beneficial. In accordance with an embodiment of the disclosure, the requested data is returned in a data message, such as a “CompData” message, which includes an indicator of where the data was sourced from. This information may be used by the gateway transmitter of the source network or the gateway receiver of the target network to predict when prefetch messages should be generated.

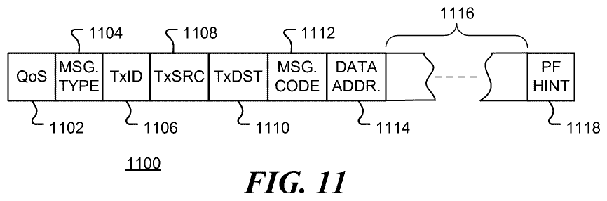

FIG. 11 is a diagrammatic representation of a read request 1100, in accordance with various representative embodiments. Read request 1100 may sent from an RN of a source chip to the C2C transmitter of the source chip and packed into a single granule of a C2C container for transmission to a target chip. Read request 1100 includes a number of data fields. The read request may take various formats, in which the relative positions and sizes of the fields are specified in the chosen message protocol. In the example shown, read request 1100 includes a quality of service (QoS) field 1102 (such as a priority level), a message type field 1104, a transaction identifier (TxID) field 1106, a transaction source field (TxSrc) 1108 that identifies the node that issued the message, a transaction destination field (TxDst) 1110 that indicates the target node for the message, a message code field 1112 that identifies the particular message, a data address field (ADDR.) 1114 that specifies the address of the location to be read, and various other fields 1116. In accordance with an embodiment of the disclosure, read request 1100 includes designated field (PF-HINT) 1118 that acts as a hint to the C2C receiver that prefetching data from the location before executing the read could be advantageous. This is a more efficient alternative to a standalone prefetch message, especially in cases where the transaction needs to traverse across the chip-to-chip link. The PF-HINT field 1118 is used by an RN to indicate that the original request had an associated prefetch message. As described above, a C2C link receiver can use this field to recreate the prefetch request if it is known that the original prefetch was dropped at the C2C link transmitter.

In one embodiment, the value of designated field 1118 is set to zero (de-asserted) to indicate that the read transaction did not include an associated prefetch message, or that this information was not available at the time the read request was sent. This indicates that there is no expected value in generating a prefetch message request at the C2C link receiver. The value of designated field 1118 is set to one (asserted) to indicate that the read transactions included an associated prefetch message. If it is known that the prefetch message was dropped at the C2C link transmitter. In this case there is value in regenerating it at the C2C link receiver.

In Arm® AMBA® 5 CHI protocol of Arm Limited, for example, the designated field 1118 may be included in “ReadNoSnp,” “ReadUnique,” “ReadShared,” “ReadPreferUnique,” “ReadOnce,” “ReadNotSharedDirty,” “ReadOnceCleanInvalid,” “ReadOnceMakeInvalid” and “ReadClean” requests. Each request having a corresponding message code in field 1112.

When designated field 1118 is asserted, the regenerated prefetch message is a hint that is sent directly to the SN associated with the read address. The SN can choose to ignore the request or fetch the data for the specified address. When the SN decides to fetch the data, it buffers it until a normal read request for that address is received. The assumption is that a separate read request will come on the normal path through a home node, in the near future. Having the data buffered at the SN reduces the latency of the memory access from a Read Transaction and hides any additional latency with local lookups in the HN-F system cache first.

Data is returned in a data message. In one embodiment, the data message uses a “DataSource” field in the data message to report the effectiveness of using prefetch message. The “DataSource” field is set by the SN (which may be a memory controller for example) or by the HN, and indicates if the read data benefited from an earlier prefetch hint.

The RN can stop issuing prefetch messages if enough are determined to be ineffective.

The C2C receiver of the target chip can stop generating and issuing prefetch messages if enough are determined to be ineffective.

To support prefetch on the target chip, the C2C receiver (or a cross-point to which it is coupled) may use a System address map that translates address to SN target identifiers.

In general, the C2C node is a gateway node or block that provides an interface to a network-to-network link.

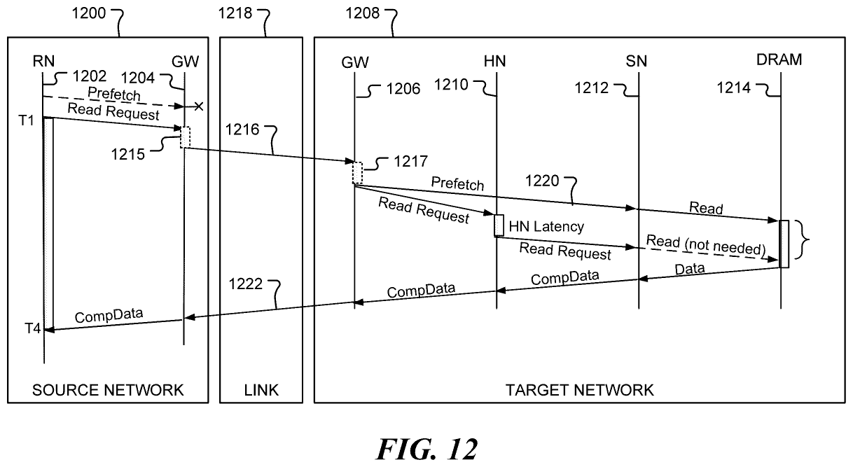

FIG. 12 is a sequence diagram illustrating a read transaction when a requesting node is in one network and the HN and SN are in different network, in accordance with various embodiments of the disclosure. The diagram shows timeline 1202 for a request node (RN) of source network 1200, timeline 1204 for a gateway node (GW) of the source network, timeline 1206 for a gateway node (GW) of target network 1208, timeline 1210 for a home node (HN) of the target network, timeline 1212 for a subordinate node (SN) of the target network and timeline 1214 for a memory device, such as a dynamic random-access memory (DRAM). Again, time flows in a downward vertical direction. Referring to FIG. 12, the RN of the source network sends a prefetch message followed by a read request to the gateway node of the source network. However, the prefetch message is dropped by the gateway transmitter of the gateway node. The read request is transmitted in message 1216 across gateway link 1218 to the gateway node of the target network. On receiving the read request, the gateway receiver of the gateway node of target network 1208 generates a prefetch message, 1220, and sends the generated prefetch message 1220 to the SN of the target network. The read request is sent to the HN of the target network, as before. In this manner, the latency reduction obtained by use of a prefetch message is maintained, but the traffic in link 1218 is reduced, since a single request is set instead of two requests. For example, in the case where a sequence of prefetch messages, with corresponding read requests, are issued by the RN, the link capacity is doubled compared to sending both the prefetch request and the subsequent read request. When the SN receives the read request from the HN, the request does not result is a read to the memory (as indicated by the dashed arrow from the SN timeline 1212 to the DRAM timeline 1214), since the data has already been requested from the DRAM in response to the prefetch message. The SN may still track the read and provide a “CompData” completion response to the incoming request. As before, the request data is returned to the RN of the source network in message 1222 via network-to-network link 1218.

In various embodiments, the data processing network includes prediction circuitry configured to determine, based on whether data associated with one or more previous read requests have been sourced from the buffer of the subordinate node or a cache of the home node, when a prefetch message will be beneficial. The prediction circuitry may be located in the gateway transmitter of the source network or the gateway receiver of the target network.

In one embodiment, the gateway transmitter in source network 1200 includes a prediction circuit that determines, based on previous link traffic for example, when a prefetch will be beneficial for a received read request. This is indicated by block 1215 in FIG. 12. When it is determined that prefetch will be beneficial, the designated field or prefetch hint in message 1216 is asserted. The hint may be asserted even in cases where no prefetch message was issued by the request node.

In one embodiment, the gateway receiver in target network 1200 includes a prediction circuit that determines, based on previous link traffic for example, when a prefetch will be beneficial for a received read request. This is indicated by block 1217 in FIG. 12. When it is determined that prefetch will be beneficial, the prefetch message 1220 is generated. The message may be generated even in cases where there is no prefetch hint in received message 1216 or when no prefetch message is received at the gateway transmitter.

The use of prediction circuitry in a request node to determine when a prefetch message should be sent is disclosed in U.S. Pat. No. 10,402,349 to Fillipo et al., for example, the subject matter of which is incorporated herein in its entirety. However, including a prediction circuit in the gateway receiver or transmitter avoids duplication of the circuitry at multiple nodes. Other prediction circuitry that could be incorporated into a gateway will be apparent to those of skill in the art.

In one embodiment, the prefetch message from the RN is always dropped at the gateway transmitter.

In one embodiment, the prefetch message from the RN is dropped at the gateway transmitter when the link traffic level is high, but transmitted when the link traffic level is low.

In one embodiment, the prefetch message from the RN is dropped at the gateway transmitter, or sent via the network-to-network link, based on the value of a configuration register.

In one embodiment, a prefetch message is generated, or not, by the gateway receiver based on the value of a configuration register.

In one embodiment, a prefetch message is generated, or not, by the gateway receiver based on the value of a designated field of a read request.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioral representations of the concepts that can be interpreted by a computer to enable simulation, functional and/or formal verification, and testing of the concepts.

Additionally, or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively, or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed of in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted, without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

1. A method comprising:
responsive to receiving, from a gateway transmitter of a source network, at a gateway receiver of a target network, a read request for data associated with an address:
generating a prefetch message at the gateway receiver for the address; and
transporting the generated prefetch message from the gateway receiver to a subordinate node of the target network; and
forwarding the read request from the gateway receiver to a home node of the target network.

2. The method of claim 1, further comprising the subordinate node:
retrieving data associated with the address responsive to receiving the generated prefetch message and storing the data in a buffer of the subordinate node; and
sending the data associated with the address responsive to the home node responsive to receiving a request for the data from the home node.

3. The method of claim 1, further comprising:
retrieving, by the subordinate node, data associated with the address responsive to receiving the generated prefetch message and storing the data in a buffer of the subordinate node;
when the data associated with the address is stored at the home node:
sending the data associated with the address from the home node to a gateway transmitter of the target network;
when data associated with the address is not stored at the home node or any other caching node of the target network:
requesting, by the home node, data associated with the address from the subordinate node;
receiving, by the home node from the subordinate node, the data associated with the address; and
sending the data associated with the address from the home node to the gateway transmitter of the target network; and
the gateway transmitter of the target network sending the data associated with the address to a gateway receiver of the source network via a network-to-network link.

4. The method of claim 1, further comprising:
identifying the home node of the target network based on the read request; and
identifying the subordinate node of the target network based on the read request.

5. The method of claim 1, further comprising:
responsive to the home node requesting data associated with the address from the subordinate node:
the subordinate node of the target network generating a message including an indication of whether or not the data associated with the address was stored in the buffer of the subordinate node; and
transporting the message to the gateway receiver of the target network via the home node; and
determining, by the gateway receiver of the target network, whether a future prefetch message should be generated, or not, based on the indication in the message.

6. The method of claim 1, further comprising:
when data associated with the address is stored at the home node:
the home node of the target network generating a message including an indication that the data associated with the address was stored at the home node; and
transporting the message to the gateway receiver of the target network;
determining, by the gateway receiver of the target network, whether a future prefetch message should be generated, or not, based on the indication in the message.

7. The method of claim 1, further comprising:
generating and transporting the prefetch message when a value of a designated field of the read request is asserted; and
not generating or transporting the prefetch message when a value of a designated field of the read request is not asserted.

8. The method of claim 7, further comprising:
generating, by a request node of the source network, the read request; and
setting, by the request node of the source network, the value of the designated field in the read request; and
transporting the read request to the gateway transmitter of the source network.

9. The method of claim 8, further comprising:
the request node of the source network sending a prefetch message for data associated with the address prior to generating the read request for data associated with the address,
where setting the value of the designated field in the read request includes asserting the value in the designated field in the read request.

10. The method of claim 9, further comprising:
transporting the prefetch message generated by the request node of the source network to the gateway transmitter of the source network; and
the gateway transmitter of the source network dropping the prefetch message.

11. The method of claim 9, further comprising:
transporting the prefetch message generated by the request node of the source network to the gateway transmitter of the source network;
when a traffic level of a network-to-network link between the source and target network is below a designated threshold:
transmitting the prefetch message over the network-to-network link to the gateway receiver of the target network; and
when the traffic level of the network-to-network link between the source and target network is not below a designated threshold:
dropping the prefetch message generated by the request node of the source network.

12. An apparatus comprising:
a target network including:
a home node associated with an address in a set of system addresses;
a subordinate node associated with the address in the set of system addresses;
a gateway transmitter; and
a gateway receiver;
where the gateway receiver of the target network is configured to:
responsive to receiving a read request for data associated with the address from a gateway transmitter of a source network:
generate a prefetch message for the address;
send the generated prefetch message from the gateway receiver to the subordinate node of the target network; and
forward the read request from the gateway receiver to the home node of the target network.

13. The apparatus of claim 12, where the subordinate node is configured to:
retrieve data associated with the address responsive to receiving the generated prefetch message and store the data in a buffer of the subordinate node; and
send data associated with the address to the home node responsive to receiving a request from the home node.

14. The apparatus of claim 13, where the target network includes a gateway transmitter and the home node is configured to:
send the data associated with the address from the home node to the gateway transmitter of the target network when data associated with the address is stored at the home node; and
when data associated with the address is not stored at the home node or any other caching node of the target network:
request data associated with the address from the subordinate node; and
send the data associated with the address to the gateway transmitter of the target network; and
the gateway transmitter of the target network is configured to:
send the data associated with the address to a gateway receiver of the source network.

15. The apparatus of claim 12, further comprising:
the source network including:
a request node;
the gateway transmitter; and
a gateway receiver; and
a network-to-network link that operatively couples the gateway transmitter of the source network to the gateway receiver of the target network and the gateway transmitter of the target network to the gateway receiver of the source network,
where the request node is operable to generate the read request for data associated with the address, and
where the gateway transmitter of the source network is configured to send the read request to the receiver of the target network via the network-to-network link.

16. The apparatus of claim 15, where the gateway receiver of the target network is configured to:
generate the prefetch message when a designated field in the read request has a first value; and
not generate the prefetch message when the designated field in the read request has a value other than the first value.

17. The apparatus of claim 16, where the source network further comprises:
a local caching node associated with the address in the set of system addresses; and
where the request node of the source network is operable to:
send a prefetch message for data associated with the address to the gateway transmitter of the source network; and
send the read request for data associated with the address to the local caching node of the source network, where the designated field of the read request is set to the first value.

18. The apparatus of claim 15, where the gateway transmitter of the source network is configured to:
transmit the prefetch message over the network-to-network link to the gateway receiver of the target network when a traffic level of the network-to-network link is below a designated threshold; and
drop the prefetch message generated by the request node of the source network when the traffic level of the network-to-network link is not below the designated threshold.

19. The apparatus of claim 15, further comprising:
prediction circuitry configured to determine, based on whether data associated with one or more previous read requests have been sourced from the subordinate node or a cache of the home node, when to send the prefetch message,
where the prediction circuitry is located in the gateway transmitter of the source network or the gateway receiver of the target network.

20. An apparatus comprising:
a target network including:
a home node associated with an address in a set of system addresses;
a subordinate node associated with the address in the set of system addresses;
a gateway receiver;
a source network including:
the gateway transmitter; and
a request node operable to send a prefetch message followed by a read request for data associated with the address to the gateway transmitter; and
a network-to-network link that operatively couples the network-to-network transmitter of the source network to the gateway receiver of the target network,
where the gateway transmitter of the source network is configured to drop the prefetch message and send the read request to the receiver of the target network via the network-to-network link, and
where the gateway receiver of the target network is configured to:
generate a prefetch message for the address;
send the generated prefetch message from the gateway receiver to the subordinate node of the target network; and
forward the read request from the gateway receiver to the home node of the target network.
